(19) United States
(12) Patent Application Publication
(10) Pub. No.: US 2004/0093198 A1
(43) Pub. Date: May 13, 2004

(54) Hardware simulation with access restrictions

(75) Inventors: William E. Neifert, Arlington, MA (US); Kevin G. Hotaling, Framingham, MA (US); Joshua D. Marantz, Brookline, MA (US); Andrew Ladd, Maynard, MA (US); Mark Seneski, Roslindale, MA (US); Stephen Butler, Gloucester, MA (US)

Correspondence Address: TESTA, HURWITZ & THIBEAULT, LLP, HIGH STREET TOWER, 125 HIGH STREET, BOSTON, MA, 02110, US

(73) Assignee: Carbon Design Systems, Waltham, MA

(21) Appl. No.: 10/702,915

(22) Filed: Nov. 6, 2003

Related U.S. Application Data
(60) Provisional application No. 60/424,930, filed on Nov. 8, 2002.

(51) Int. Cl. G06F 17/50

(52) U.S. Cl. 703/14

(57) ABSTRACT

Access is restricted to software objects that simulate the operation of electronic devices from register transfer level descriptions thereof. Objects are initially provided in an inaccessible state, typically as object code. A “player” module mediates user access to the simulation object, allowing the user to link to it and otherwise perform the simulation it encodes, but only in response to satisfaction of one or more authorization criteria. The nature of these criteria depend on the reason for the restriction and the party benefited.

### RELATED APPLICATION

This application claims priority to and the benefits of U.S. Provisional Application Serial No. 60/424,930, filed on Nov. 8, 2002 (the entire disclosure of which is hereby incorporated by reference).

### TECHNICAL FIELD

The invention relates to the field of simulation of electronic hardware devices. In particular, the invention relates to compilation of a description of an electronic device, such as a Verilog RTL description into a software object that simulates the behavior of the device.

### BACKGROUND

Electronic hardware design is typically performed using register transfer level (RTL) descriptions of the device being designed. Hardware description languages, such as Verilog, allow hardware designers to describe the electronic devices that they are designing in a format that facilitates fabrication.

Actually producing prototype electronic devices, however, particularly complex integrated circuits, is time-consuming and expensive. As a result, simulation systems have been developed to permit hardware designs to be verified prior to actually producing an electronic device. Typically, a description of an electronic device is exercised using a simulator. The simulator generally includes a simulation kernel that runs the simulation either in software, or using simulation hardware, which may consist of a collection of programmable logic devices or specially designed processing units. Use of simulation for the purpose of verifying hardware designs is a regular part of the hardware design cycle.

Software simulation systems, such as that described in the '930 application, transform a coded description of an electronic device written in a hardware description language—such as Verilog RTL—into a simulation of the device. Such systems may utilize global analysis techniques (i.e., analysis of the design of the electronic device as a whole) to produce cycle-accurate simulations of hardware devices. The resulting simulation often takes the form of a software object, which can be linked to software under design in order to simulate the behavior of the device when running the software.

Software systems may outperform hardware simulators (sometimes dramatically) in terms of processing speed and cost, and do not require dedicated equipment. Moreover, simulation objects may be easily disseminated to software developers, permitting multiple, geographically dispersed users to simultaneously and independently perform hardware validation. As errors are detected, the hardware design may be refined and compiled into a new object, which may again be disseminated to developers. This flexibility in terms of time and place of use represents a significant advantage over hardware systems that utilize dedicated equipment. Still, the disadvantage of fixed-site equipment can provide one benefit: users are easily monitored and can be physically restricted.

The need to control or at least monitor access to simulation objects can be important to various parties. Consider a scenario in which a compiler, which generates simulation objects from hardware specifications, is produced by a software company that licenses the compiler to hardware designers. The hardware designers, in turn, generate simulation objects for their hardware they develop, and transfer these to software developers who validate the hardware design in the course of creating software for their own customers (who will also purchase the hardware). In these circumstances, it may be critical for the compiler vendor to be able to track the identities of the ultimate end users, and possibly even to enter into separate agreements with them. For example, if the compiled software objects embody elements of the compiler itself, the compiler's owner may insist on entering into license agreements not only with its own customers, the hardware designers, but with their customers (the software developers) as well. If the compiler's owner structures its license terms based on a per-user fee for each object generated—an approach that reflects the economic value of the compiler to the hardware designers, i.e., the compiler vendor's customers—it will at least need to keep track of the number of object instances in use.

From the perspective of the hardware designer, the prospect of “loose” objects embodying proprietary hardware designs may be intolerable if aspects of the designs may be inferred from the simulation, or simply due to the need to protect relationships with favored developers who are granted early and/or exclusive access to the designs. Accordingly, a need exists for approaches that facilitate unfettered dissemination of simulation objects while providing for retention of control over the circumstances in which the objects are accessed and by whom.

### SUMMARY OF THE INVENTION

In accordance with the invention, objects are initially provided in an inaccessible state, typically as object code. A “player” module mediates user access to the simulation object. In particular, the player module provides an interface to the object, allowing the user to link to it and otherwise perform the simulation it encodes, but only in response to satisfaction of one or more authorization criteria. The nature of these criteria depend on the reason for the restriction and the party benefited.

For example, the vendor of a simulation-object compiler may license the compiler and a fixed number of players to its customers. Each customer may compile objects without restriction, but the maximum number of objects accessible at any one time is limited by the number of players issued to the customer, i.e., for which the customer has paid. The vendor's customers, in turn, may compile simulation objects representing hardware designs and distribute these objects, each along with a player, to software developers who will validate the hardware design. In order to prevent unauthorized redistribution of simulation objects transferred to specific developers, one authorization criterion may be an identifier associated with a designated computer. An additional criterion may be verification that the identified computer is, in fact, owned by the developer to whom the object was transferred.

This information may be transmitted to the hardware designer and/or to the compiler vendor in order to enable them to track the authorized location of each player. Moreover, access to the object can be further conditioned on execution, by the player recipient, of an agreement benefiting an upstream party, i.e., the hardware designer and/or the compiler vendor; that is, execution of the agreement can be another authorization criterion. For example, the agreement may be a license from the compiler vendor governing use of the player. Alternatively or in addition, the agreement may be a contract from the hardware designer specifying the terms of the relationship with the player recipient and the manner in which the player and object may be permissibly used.

The player may be an independent, stand-alone program or may be embedded within an object. For example, the compiler may be configured to generate players as part of the simulation objects it produces, but the user may be restricted as to how many objects s/he can execute at a given time (e.g., without payment of additional licensing fees). Alternatively, the user may pay for a given number of players, which are sequentially incorporated into objects as the compiler generates them. When the number of licensed players has been used up, the compiler will no longer generate playable objects (so that instead of licensing a compiler along with a fixed number of players, the vendor instead licenses a compiler configured to compile only the number of objects for which the licensee has paid). The compiler, in either case, embeds the authorization criteria along with the interface instructions within the objects as they are generated. Such criteria may still involve communication with an upstream party; the instructions implementing, for example, acceptance of an agreement and registration with the upstream party are simply implemented as embedded instructions rather than within a separate program.

Accordingly, in a first aspect, the invention comprises a computational module for facilitating access to a computational hardware simulation object. The module comprises instructions facilitating establishment of an interface to the simulation object, and instructions implementing an authorization module precluding access to the interface prior to satisfaction of at least one authorization criterion. In some embodiments, the authorization criterion is implemented through the use of a key, which is provided to the authorization module upon satisfaction, by the player's user, of the authorization criterion. For example, the player may be paired with a specific key, which is provided (i.e., transmitted to the computer on which the player is operative) by an upstream party in response to the user's registration and/or acceptance of an agreement. (That is, the authorization module comprises instructions facilitating communication with a remote server, and the key is issued by the remote server in response to satisfaction of an authorization condition.) In order to confine use of the player to the computer from which registration takes place, the upstream party may obtain an identifier uniquely associated with that computer, and then generate the key using the identifier. Alternatively, the player may be transferable among and operable on a plurality of computers, but access to the interface is possible only following provision of a computer-specific key. In still another alternative, a biometric indicium is used to confine use of the player to a particular individual rather than to a particular computer.

In another aspect, the invention comprises a method of facilitating controlled access to a computational hardware simulation object. In accordance with the method, an interface to the simulation object is established, and user access to the object via the interface is precluded prior to satisfaction of at least one authorization criterion. As above, the authorization criterion can involve provision of a key, which may, for example, be issued to the user by an upstream party upon user execution or acceptance of an agreement, or registration. The key may be specific to a particular computer.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 is a block diagram showing the flow of a system for generating and controlling access to simulations according to an embodiment of the invention;

FIG. 2 schematically illustrates a hardware embodiment of the invention and its operation;

FIG. 3 is a workflow diagram illustrating interaction among various components of the invention and parties utilizing them; and

FIG. 4 is a block diagram of a player in accordance with the invention.

### DETAILED DESCRIPTION OF THE PREFERRED EMBODIMENTS

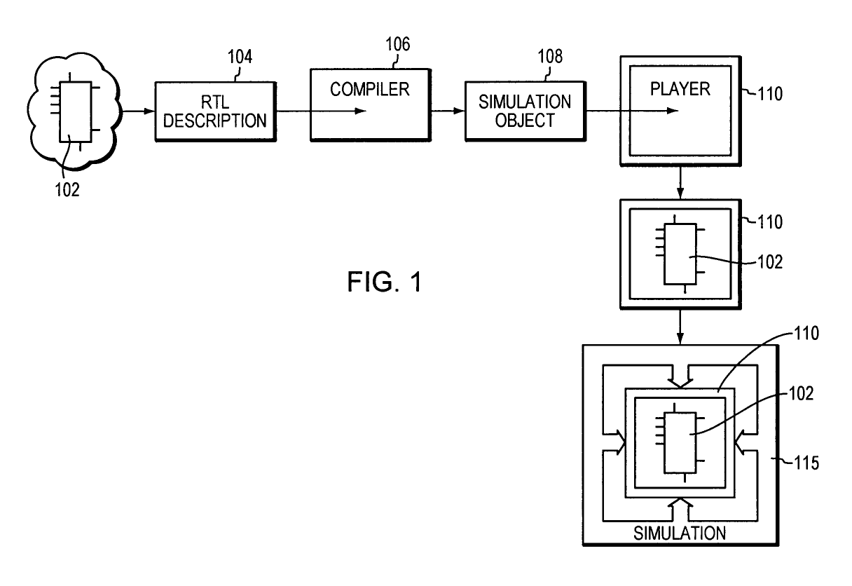

With reference to FIG. 1, which conceptually illustrates the operation of certain key features of the invention, the designer of an electronic device 102 first describes the device in terms of a hardware description language, e.g., as a Verilog RTL file 104 (although the invention may utilize different hardware descriptions or hardware description languages). The electronic device 102 may be, for example, an electronic chip, a small functional block of a chip, numerous chips that make up a complete system, or any other combination of electronic components.

The RTL description 104 represents a complete functional characterization of the device 102. Preferably, the hardware is described at a register transfer level (i.e., specifying the registers of the device and the manner in which data is transferred among them) rather than at a lower level, such as a gate level. Interconnections within the hardware may be described as vectors, rather than requiring each wire of, for example, a wide bus to be described separately. In any case, the description 104 contains sufficient detail to permit a software simulation of the system to be generated, and the description 104 is processed by a compiler 106 into a software simulation object 108. The object 108 may be used to simulate the operation of the actual device 102 in order, for example, to facilitate development and testing of software that will be used with the device 102 before it is physically available. In other words, software representations of the data signals that would be applied to the terminals of the device 102 are provided to the object 108, which not only responds with data representative of the output signals that the device 102 would generate, but also maintains an internal representation of the register operations underlying the device output. These may be analyzed to investigate device behavior and identify potential design problems, allowing software development to proceed in parallel with hardware development and thereby reducing overall time to market.

The nature and operation of the compiler 106 are not critical to the present invention. A compiler suitable for present purposes is described in the '930 application. Briefly, the compiler 106 translates the description 104 into an internal format. This internal format may facilitate “global analysis”—i.e., analysis that is performed on the entire hardware design, crossing module boundaries, rather than on a module-by-module or smaller-scale basis—of the hardware design embodied in the description 104. The compiler 106 performs such global analysis to optimize the simulation that it generates. As part of this global analysis, the compiler 106 schedules the elements of the hardware design with regard to relevant clock edges and other events. In some embodiments, the resulting simulation object 108 need only be cycle-accurate, rather than timing-accurate, since the simulation is used primarily to permit early design and testing of software for use with a hardware design. A compiler in accordance with the '930 application may include a parser, which analyzes the RTL description 104, a database formation module, a local analysis module, an elaboration module, a global analysis module, and a code generation module.

The simulation object 108 may contain attributes and procedures, as are normally defined in object-oriented programming methodologies. The ”encapsulation” of procedures within the objects themselves reduces the programming burden on applications designed to interact with objects; those applications need not “know” the internal details of device representation, since each object carries its own structure and effectively orchestrates its own behavior. Objects may also possess the property of heritability, whereby properties or attributes of hierarchically superior objects are automatically inherited by hierarchically inferior objects. Heritability is managed by organizing the objects into classes, each of which represents the template for a set of similar (in the sense of sharing structure and behavior) objects. Each object is an instance of some class. Thus, objects in a subclass automatically acquire the procedures associated with hierarchically superior objects.

Objects can also be linked to one another. A linked object, while not contained in the linking object in the manner of a lower-tier object, is nonetheless referenced in the linking object. The procedures associated with the linking object determine the significance of the reference and its effect. Management of object classes, attributes, encapsulated procedures and inter-object linkages occurs through an object-oriented database system, design and implementation of which are well-known in the art. Thus, the simulation object 108 may in actuality be a series of linked, individual objects.

Software programs written for the device 102 do not interact directly with the simulation object 108, but instead interact with a transactional “player” 110 that mediates the data flow. The player 110, in effect, allows external software to “play” the simulation embodied in the object 108, providing an application programming interface (API) that mediates between the internal object representation of the device 102 and an external program 115 designed for interaction with an actual hardware device. The player 110 thereby provides an abstraction layer, translating the functionality invoked via the API into inputs, outputs, and clock cycles that are handled by the simulation object 108. For example, the simulation object 108 may operate cycle-by-cycle, whereas functions provided through the player 110 may be multiple cycles. Thus, the player 110 may receive an instruction from an external program via the player's API to carry out a multi-cycle function, which will then be executed by the player 110 by operating the inputs and outputs of the simulation object 108 on a cycle-by-cycle basis.

For example, if the hardware being simulated is a network interface designed for use on a laptop computer, which supports a PCI bus interface, a USB port interface, or a PCMCIA interface, then the simulation object 108 will simulate the hardware of the network interface chip. The software program 115 may, for example, be diagnostic software, designed to test the network interface chip. For each bus type (i.e., PCI, USB, and PCMCIA) supported by the chip, the player 110 may contain a different instance of the API.

In some embodiments, the API, the player 110, and the simulation object 108 are all linkable object code that are ultimately linked to the software program 115. In some embodiments, the API may provide functionality compatible with known interfaces to hardware simulations, such as PLI. Such compatibility may permit software that has been prepared for use with previously known simulation systems to be used with a software simulation prepared by the compiler 106. In some embodiments, the history of inputs and outputs of the simulation object 108 are recorded as the software program 115 interacts with it. The recorded inputs and outputs (as well as internal operations, such as register transfers, to the extent desired) may be stored in a data file according to a procedure encapsulated in the object 108.

The stored data is available for analysis and later, if the simulation is re-executed, recorded inputs and outputs may be used to dramatically speed up execution of the simulation. At each clock cycle beginning with the first cycle, if the inputs to the simulation object 108 are the same as the recorded inputs, then the outputs should be the same as the recorded outputs. This permits the simulation object 108 to produce the correct outputs without executing the simulation, potentially resulting in substantial speedup of the system.

The software implementing the compiler 106 and the player 110 may be written in any one of a number of high-level languages, such as C, C++, LISP, or Java. Further, portions of the software may be written as script, macro, or functionality embedded in commercially or freely available software. Additionally, the software may be implemented in an assembly language directed to a microprocessor, such as an Intel 80×86, Sun SPARC, or PowerPC microprocessor. The software may be embedded on an article of manufacture including, but not limited to, a “computer-readable medium” such as a floppy disk, a hard disk, an optical disk, a magnetic tape, a PROM, an EPROM, or CD-ROM.

Furthermore, although the player 110 is illustrated as a separate module in FIG. 1 that conceptually “contains” the simulation object 108, this need not be the case. For example, the player 110 may be contained within (i.e., be represented as a procedure internal to) the simulation object 108. Accordingly, while the ensuing discussion will treat the player as a separate software module, it should be understood that this is solely for convenience of presentation.

Another function provided by the player 110, critical to the present invention, is access restriction. In particular, the player 110 may preclude access to the simulation object 108 (e.g., by disabling the API) until an authorization criterion is satisfied. In one embodiment, the authorization criterion involves provision of a key matching a stored template stored in (or accessed for verification purposes by) the player 110. The key can be any sort of identifier appropriate to the deployment, as described below.

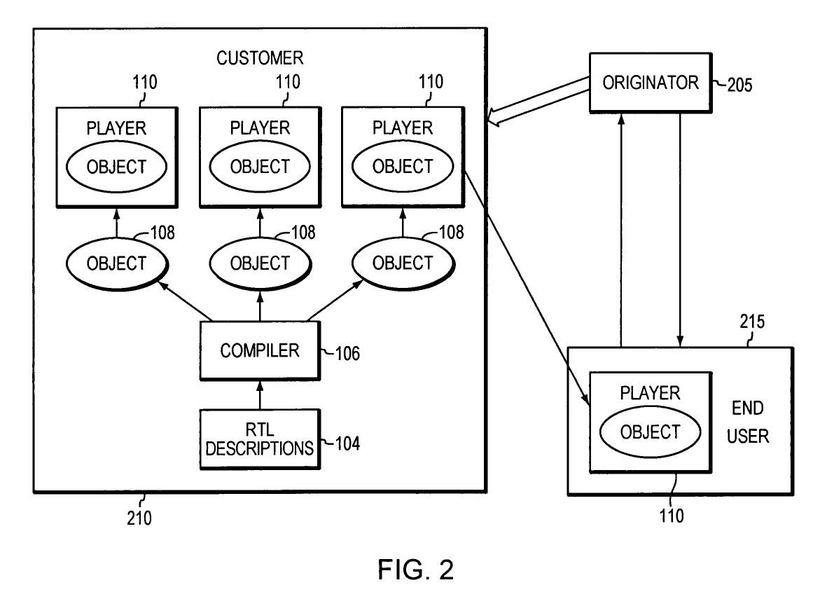

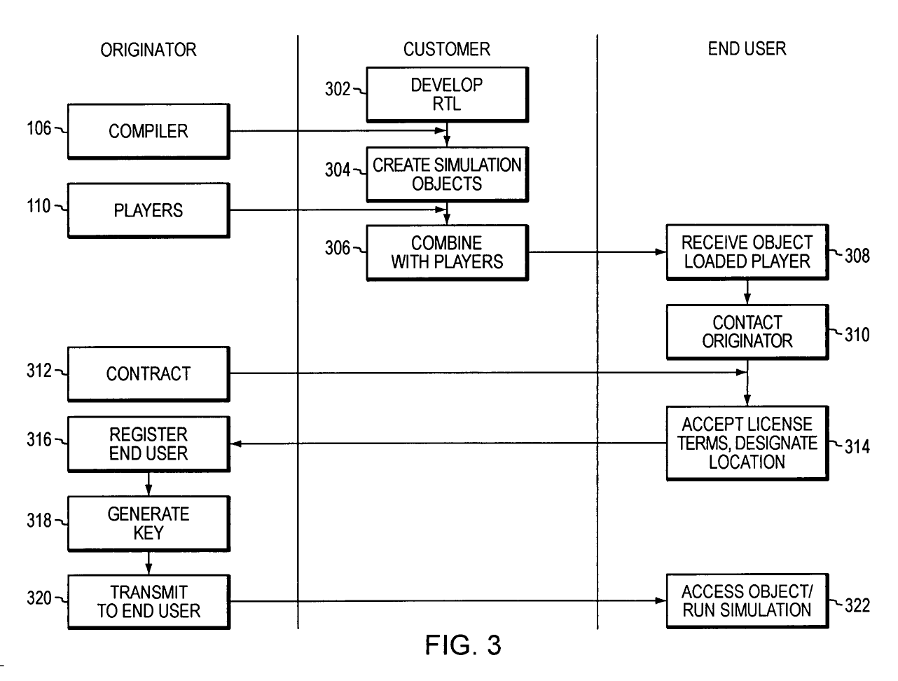

FIGS. 2 and 3 illustrate the manner in which the components of the embodiment described above may be distributed and utilized in a typical deployment. The originator 205 has developed and markets the compiler 106 and players 110. It provides these, generally pursuant to a suitable license agreement, to a customer 210. The customer 210, in turn, generates RTL descriptions 104 of its hardware designs (step 302 in FIG. 3), and uses the compiler 106 to create objects 108 (step 304). The customer's agreement with the originator 205 entitles it to a fixed number of players 110, which it utilizes to gain programmatic access to the generated objects 108 (step 306).

The customer 210 is then free to disseminate the players 110, each bound to a particular object 108, to end users, one of which is representatively indicated at 215 in FIG. 2. The end users 215 may be, for example, developers who will validate the hardware design embodied in an RTL description 104. Where the players 110 and the objects 108 are separate entities, the end user 215 is generally free to bind a player 110 to any selected simulation object 108.

The player 110 is generally configured such that, once it has been received by the end user 215 (step 308), some interaction with at least one upstream party—i.e., the customer 210 and/or the originator 205—is generally required before the end user 215 will be allowed to access and use the player 110 and its simulation object 108. In a typical scenario, the originator 205 wishes to maintain awareness of the locations and identities of end users 215, and may further wish to enter into express license agreements with them, since the player 110 belongs to the originator 205 and the object 108 may, having been derived from the originator's compiler 106, contain proprietary code of the originator 205. At the very least, maintaining awareness of the end users 215 currently using players 110 allows the originator 205 to verify compliance on the part of the customer 210 with the terms of their agreement, e.g., that the customer 210 has not somehow deployed more players 110 than it has licensed. Alternatively or in addition, the customer 210 may wish to enter into a proprietary-information agreement with the end user 215, since the latter will have access to the customer's proprietary hardware designs. The end user's assent to any such agreements can be facilitated electronically, through network-based interaction with the appropriate upstream party and using conventional “click-wrap” licensing modalities.

In the illustrated embodiment, the end user 215 contacts the originator 205 (step 310), e.g., through interaction with a web site maintained by the originator 205. This interaction may involve provision (e.g., on an HTML form) of information identifying the end user 215 and supplying contact and location information. Upon processing this information, the originator 205 (generally through an automated process operating on a web server) transmits an agreement 312 (typically an end-user license) to the end user, e.g., as a web page. The user is free to accept or decline the offered terms (step 314), generally by selecting an “Accept” or “Decline” radio button on the license web page. If the end user 215 accepts, s/he may be asked to designate a computer upon which the player 110 will operate. The originator 205 registers the end user 215 based on the information the end user has provided (step 316), and generates a key (step 318) that will facilitate access to the player 110. The originator 205 transmits the key to the end user 215 (step 320), typically via e-mail, and the end user's provision of the key to the player 110 accords access thereto (step 322).

In some embodiments, the key is a simple, unique random string supplied by the originator 205 and stored on the player 110. In other embodiments, the key is a “private” key for use in a conventional “public key encryption” scheme embodied in the player 110. This approach can be used to facilitate subsequent encrypted message passing from the originator 205 to the end user 215. If the originator 205 wishes to confine player access to a single computer designated by the end user 215, the end user 215 is asked to identify the computer, and the key may be derived from an identifying number or string unique to that machine. In particular, the identifier may be obtained either through direct interaction with the end user 215, who supplies the information, or by means of an application resident on the player 110 (or an applet transmitted to the designated computer) which, when executed on the player 110, automatically obtains the identifying information and transmits it to the originator 205. If the originator 205 wishes to confine player access to a single designated individual rather than a particular computer, the key may be a biometric indicium (e.g., data representative of a fingerprint) associated with the designated individual.

The originator 205 may also wish to ensure that a designated computer is, in fact, owned by the end user 215. This may be accomplished in any of various ways, e.g., obtaining an explicit acknowledgment by the end user 215 to this effect or, if the designated computer has an Internet address, verifying that this address is within the end user's Internet domain.

In any case, when the end user 215 is finished using the player 110, it may be returned to the customer 210, which is free to re-transmit it to another end user 215, or to bind it to a new object 108 and thereupon transmit the new combination.

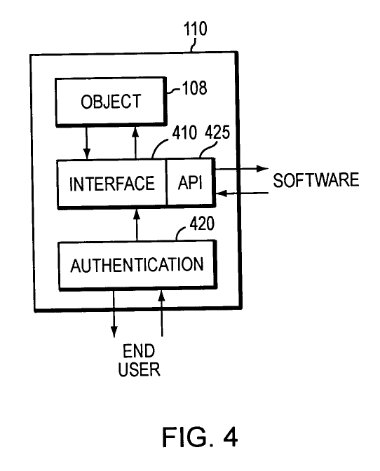

Refer now to FIG. 4, which illustrates the internal components of a representative player 110. The player includes software instructions facilitating establishment of an interface 410 to the simulation object 108, and instructions implementing an authorization module 420 that precludes access to the interface prior to satisfaction of one or more authentication criteria. The interface 410 includes an API 425 as described above, and interacts externally with the software program utilizing the simulation (i.e., designed to operate the simulated hardware device). The authentication module 420 generally interacts with the end user and/or the end user's computer to obtain the authorization criterion. In some embodiments, however, the authorization module 420 may interact directly with an upstream party (i.e., with an upstream party's server), at least the first time the player 110 is accessed, to verify initial satisfaction of the authentication criterion.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A computational module for facilitating access to a computational hardware simulation object, the module comprising:
a. instructions facilitating establishment of an interface to the simulation object; and
b. instructions implementing an authorization module precluding access to the object via the interface prior to satisfaction of at least one authorization criterion.

2. The module of claim 1 wherein the authorization criterion comprises provision of a key to the authorization module.

3. The module of claim 2 wherein the authorization module comprises instructions facilitating communication with a remote server, the key being issued by the remote server in response to satisfaction of an authorization condition.

4. The module of claim 1 wherein the authorization module comprises instructions internal to the object, the authorization criterion comprising an identifier associated with a single designated computer.

5. The module of claim 4 wherein the authorization criterion further comprises satisfaction of an authorization condition.

6. The module of claim 3 wherein the authorization condition comprises acceptance of a license.

7. The module of claim 5 wherein the authorization condition comprises acceptance of a license.

8. The module of claim 1 wherein the instructions facilitating establishment of an interface and the instructions implementing an authorization module are contained in a stand-alone program separate from the object.

9. The module of claim 1 wherein the instructions facilitating establishment of an interface and the instructions implementing an authorization module are internal to the object.

10. The module of claim 2 wherein the key is specific to a designated computer such that access to the interface is possible only via the designated computer.

11. The module of claim 10 wherein the module and the object are transferable among and operable on a plurality of computers but access to the object via the interface is possible only following provision of a computer-specific key.

12. A method of facilitating controlled access to a computational hardware simulation object, the method comprising the steps of:
a. establishing an interface to the simulation object; and
b. precluding user access to the object via the interface prior to satisfaction of at least one authorization criterion.

13. The method of claim 12 wherein the authorization criterion comprises provision of a key to the authorization module.

14. The method of claim 13 further comprising the step causing a remote server to issue the key in response to satisfaction of an authorization condition.

15. The method of claim 12 wherein the authorization criterion comprises an identifier associated with a single designated computer.

16. The method of claim 12 wherein the authorization criterion comprises a biometric indicium associated with a designated individual.

17. The method of claim 12 wherein the authorization criterion comprises satisfaction of an authorization condition.

18. The method of claim 17 wherein the authorization condition comprises acceptance of a license.

19. The method of claim 17 wherein the authorization condition comprises registration with a third party.

20. The method of claim 13 wherein the key is specific to a designated computer such that access to the interface is possible only via the designated computer.

21. The module of claim 10 wherein the object and the interface are transferable among and operable on a plurality of computers but access to the object via the interface is possible only following provision of a computer-specific key.
